(19) United States
(12) Patent Application Publication
(10) Pub. No.: US 2022/0114397 A1
(43) Pub. Date: Apr. 14, 2022

(54) APPARATUS AND METHOD FOR EVALUATING THE PERFORMANCE OF DEEP LEARNING MODELS

(71) Applicant: SAMSUNG SDS CO., LTD., Seoul (KR)

(72) Inventors: Hee Sung YANG, Seoul (KR); Joong Bae JEON, Seoul (KR); Ju Ree SEOK, Seoul (KR)

(21) Appl. No.: 17/080,312

(22) Filed: Oct. 26, 2020

(30) Foreign Application Priority Data
Oct. 8, 2020 (KR) 10-2020-0130209

(51) Int. Cl. G06K 9/62; G06N 3/02

(52) U.S. Cl. CPC G06K 9/6262; G06K 9/628; G06N 3/02; G06K 9/6259; G06K 9/6202; G06K 9/6292

(57) ABSTRACT

An apparatus for evaluating the performance of a deep learning model according to an embodiment may include an image processor configured to generate N (N≥2) different second image data through data augmentation of first image data that is not labeled and transmit the generated second image data to a deep learning model, and an analyzer configured to analyze whether the deep learning model has output a correct answer by receiving N output data obtained by predicting each of the N second image data into a specific class from the deep learning model.

### TECHNICAL FIELD

The disclosed embodiments relate to a technique for evaluating the performance of a deep learning model.

### BACKGROUND ART OF THE INVENTION

In general, in order to evaluate the performance of a deep learning model, separate test data that are not used for training data is used. At this time, the test data is data labeled with a ground truth, and the test data is used to measure the accuracy of the deep learning model to evaluate the model's performance.

However, much time and labor are required to generate labeled test data. In particular, when a deep learning model is applied to an automated system or the like, performance evaluation of the deep learning model is periodically required according to the aging of the system, but it is difficult to generate labeled test data for each performance evaluation.

### SUMMARY

Disclosed embodiments are intended to provide a method and apparatus for evaluating the performance of a deep learning model using unlabeled image data.

An apparatus for evaluating the performance of a deep learning model according to an embodiment may comprise an image processor configured to generate N (N≥2) different second image data through data augmentation of first image data that is not labeled and transmit the generated second image data to a deep learning model, and an analyzer configured to analyze whether the deep learning model has output a correct answer by receiving N output data obtained by predicting each of the N second image data into a specific class from the deep learning model.

The image processor may be further configured to generate the different second image data by applying the same type of data augmentation to the first image data, or generate the different second image data by applying different types of data augmentation to the first image data.

The analyzer may be further configured to compare classes indicated by the N output data and, when all the indicated classes are the same, determine that the deep learning model has output a correct answer.

The analyzer may be further configured to check a number of each class indicated by the N output data and, when a ratio of a largest number of classes is greater than or equal to a predetermined reference, determine that the deep learning model has output a correct answer.

The analyzer may be further configured to determine test image data by classifying first image data for which the deep learning model is determined to have output a correct answer into a class predicted by the deep learning model.

The image processor may be further configured to receive the first image data determined by the analyzer as the test image data and generate N third image data by synthesizing two or more first image data classified into different classes among the first image data determined as the test image data.

The analyzer may be further configured to receive N output data obtained by predicting each of the N third image data into a specific class from the deep learning model and analyze whether the deep learning model has output a correct answer.

A method for evaluating performance of a deep learning model according to an embodiment may comprise generating N (N≥2) different second image data through data augmentation of first image data that is not labeled; transmitting the N second image data to a deep learning model; and analyzing whether the deep learning model has output a correct answer by receiving N output data obtained by predicting each of the N second image data into a specific class from the deep learning model.

The generating of the N (N≥2) different second image data may include generating the different second image data by applying the same type of data augmentation to the first image data, or generating the different second image data by applying different types of data augmentation to the first image data.

The analyzing may include comparing classes indicated by the N output data and, when all the indicated classes are the same, determining that the deep learning model has output a correct answer.

The analyzing may include checking a number of each class indicated by the N output data and, when a ratio of a largest number of classes is greater than or equal to a predetermined reference, determining that the deep learning model has output a correct answer.

The analyzing may include determining test image data by classifying first image data for which the deep learning model is determined to have output a correct answer into a class predicted by the deep learning model.

The method may further include generating N third image data by synthesizing two or more first image data classified into different classes among the first image data determined as the test image data.

The method may further include receiving N output data obtained by predicting each of the N third image data into a specific class from the deep learning model and analyzing whether the deep learning model has output a correct answer.

### BRIEF DESCRIPTION OF THE DRAWINGS

FIG. 1 is a block diagram illustrating a configuration of an apparatus for evaluating the performance of a deep learning model according to an embodiment;

FIG. 2 is an exemplary diagram for explaining an operation of an image processor according to an embodiment;

FIG. 3 is an exemplary diagram for explaining an operation of an analyzer according to an embodiment;

FIG. 4 is an exemplary diagram for explaining an operation of an image processor according to an embodiment;

FIG. 5 is a flowchart illustrating a method of evaluating the performance of a deep learning model according to an embodiment; and

FIG. 6 is a block diagram illustrating an example of a computing environment including a computing device according to an embodiment.

### DETAILED DESCRIPTION

Hereinafter, specific exemplary embodiments of the present disclosure will be described with reference to the drawings. The following detailed description is provided to assist in comprehensive understanding of methods, apparatuses, and/or systems described herein. However, this is merely an example, and the present disclosure is not limited thereto.

When detailed description of known art related to the present disclosure is determined to unnecessarily obscure the subject matter of the present disclosure in describing exemplary embodiments of the present disclosure, the detailed description will be omitted. The terms to be described below are terms defined in consideration of functions in the present disclosure and may be changed according to an intention of a user or an operator or practice. Therefore, definitions thereof will be determined based on content of the entire specification. The terms used in the detailed description are merely intended to describe the exemplary embodiments of the present disclosure and should not be limited in any way. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, operations, operations, elements, and/or components, but do not preclude the presence or addition of one or more other features, integers, operations, operations, elements, components, and/or groups thereof.

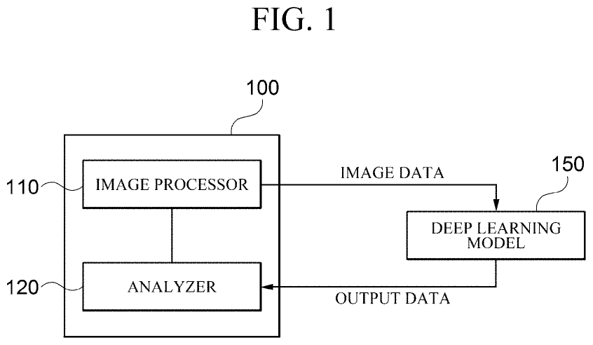

FIG. 1 is a block diagram illustrating a configuration of an apparatus for evaluating the performance of a deep learning model according to an embodiment.

Referring to FIG. 1, the apparatus 100 for evaluating the performance of a deep learning model may include an image processor 110 and an analyzer 120.

According to an example, the image processor 110 may transmit predetermined image data for evaluating the performance of a deep learning model to a deep learning model 150, and the analyzer 120 may receive output data obtained by analyzing predetermined image data from the deep learning model 150 and analyze the received output data.

According to one embodiment, the image processor 110 may generate N (N≥2) different second image data through data augmentation of first image data that is not labeled. Then, the image processor 110 may transmit the second image data to the deep learning model.

According to an example, data augmentation may be any one of the following methods: rotation, flip, resize, distortion, crop, cutout, blur, and mix, or a combination of two or more thereof.

In one example, the image processor 110 may generate the second image data by applying rotation to one first image data. In another example, the image processor 110 may generate the second image data by applying rotation and flip to one first image data. In still another example, the image processor 110 may generate the second image data by synthesizing two or more first images.

According to an embodiment, the image processor 110 may generate different second image data by applying the same type of data augmentation to the first image data.

For example, the image processor 110 may receive M first image data, and may generate N second image data for each of the M first image data by applying rotation to the M first image data.

In another example, the image processor 110 may receive M first image data, and generate N second image data for each of the M first image data by applying rotation and flip to the M first image data.

According to an embodiment, the image processor 110 may generate different second image data by performing different types of data augmentation on the first image data.

For example, the image processor 110 may receive M first image data, rotate some of the M first image data to generate N second image data for each of some of the M first image data, and flip the remaining first image data to generate N second image data for each of the remaining first image data.

In another example, the image processor 110 may receive M first image data, apply rotation and flip to some of the M first image data to generate N second image data for each of some of the M first image data, and apply distortion and cutout to the remaining first image data to generate N second image data for each of the remaining first image data.

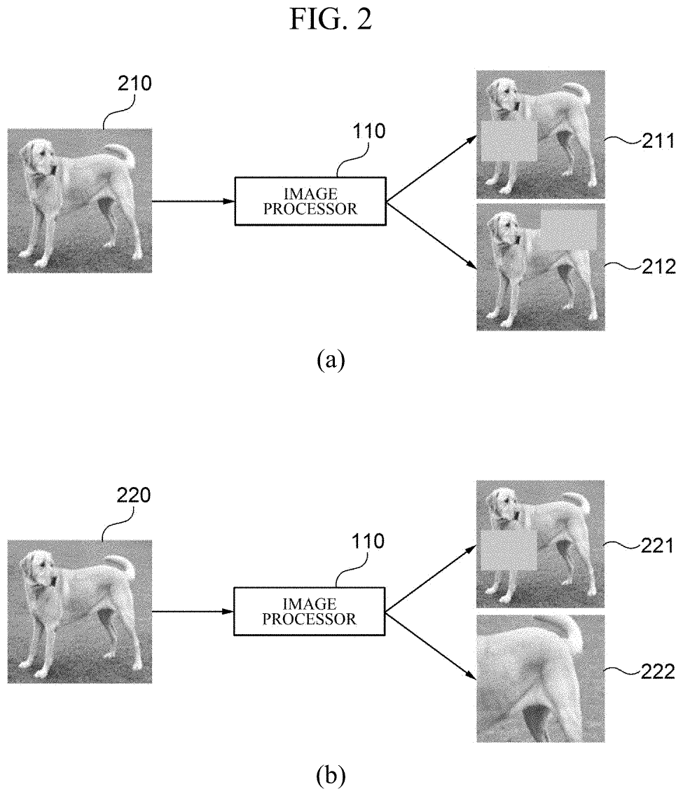

FIG. 2 is an exemplary diagram for explaining an operation of the image processor according to an embodiment.

According to an example, data augmentation may be any one of the following methods: rotation, flip, resize, distortion, crop, cutout, blur, and mix, or a combination of two or more thereof.

For example, the image processor 110 may generate two or more second image data by applying the same type of data augmentation to first image data.

Referring to FIG. 2(A), the image processor 210 may generate two second image data 211 and 212 by applying cutout to first image data 210. At this time, the position to which the cutout is applied may be different.

For example, the image processor 110 may generate two different second image data by applying different types of data augmentation to the first image data.

Referring to FIG. 2(B), the image processor 210 may apply cutout to the first image data 220 to generate second image data 221, and apply cropping and resizing to the first image data 220 to generate second image data 222. At this time, the positions to which the cutout and the cropping and resizing are applied may be different.

According to an embodiment, the analyzer 120 may analyze whether the deep learning model 150 has output a correct answer by receiving N output data obtained by predicting each of the N second image data into a specific class from the deep learning model 150.

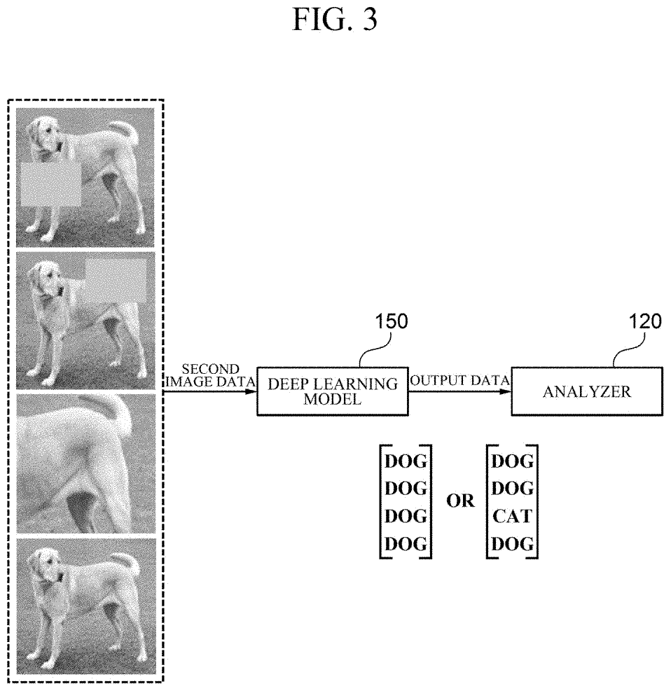

FIG. 3 is an exemplary diagram for explaining an operation of the analyzer according to an embodiment.

Referring to FIG. 3, the image processor 110 may generate four second image data and transmit the generated second image data to the deep learning model 150. Then, the deep learning model 150 may predict a class of each of the second image data, and generate basic output data based on the prediction result.

For example, as shown in FIG. 3, the deep learning model 150 may predict a class of each of four second image data as [dog, dog, dog, dog] and generate output data according to the prediction result, or may predict the class as [dog, dog, cat, dog] and generate output data. Then, the deep learning model 150 may transmit the generated output data to the analyzer 120.

According to an embodiment, the analyzer 120 may compare classes indicated by N output data, and when all indicated classes are the same, it may be determined that the deep learning model has output a correct answer.

For example, where classes indicated by the output data received by the analyzer 120 are [dog, dog, dog, dog], the analyzer 120 may compare the classes indicated by the output data and find that all the indicated classes are the same. Then, the analyzer 120 may determine that the deep learning model 150 has output a correct answer since the finding corresponds to a case where all classes indicated by the output data are the same.

In another example, where classes indicated by the output data received by the analyzer 120 are [dog, dog, cat, dog], the analyzer 120 may compare the classes indicated by the output data and find that the indicated classes are not the same. Then, the analyzer 120 may determine that the deep learning model 150 has output an incorrect answer since the finding does not correspond to a case where all classes indicated by the output data are the same.

According to an embodiment, the analyzer 120 may check the number of each class indicated by the N output data, and, when the ratio of the largest number of classes to the total number of classes is greater than or equal to a predetermined reference, the analyzer 120 may determine that the deep learning model has output a correct answer.

For example, as shown in FIG. 3, the deep learning model 150 may receive four second image data and generate output data according to four prediction results. For example, when classes indicated by three or more output results among the four prediction results are the same, the analyzer 120 may determine that the deep learning model 150 has output a correct answer.

For example, where classes indicated by the output data received by the analyzer 120 are [dog, dog, dog, dog], the analyzer 120 may check the number of each class indicated by the output data, and as a result of checking, may find that the number of [dog] classes is 4. Then, the analyzer 120 may determine that the deep learning model 150 has output a correct answer since the number of [dog] classes is three or more among the classes indicated by the output data.

In another example, where classes indicated by the output data received by the analyzer 120 are [dog, dog, cat, dog], the analyzer 120 may check the number of each class indicated by the output data and as a result of checking, may find that the number of [dog] classes is 3 and the number of [cat] classes is 1. Then, the analyzer 120 may determine that the deep learning model 150 has output a correct answer since the number of [dog] classes is three or more among the classes indicated by the output data.

According to the above embodiments, the analyzer 120 may determine whether the analysis result of the deep learning model 150 which analyzes the first image data that is not labeled is a correct answer.

According to an embodiment, the analyzer 120 may determine the first image data as test image data by classifying the first image data for which the deep learning model 150 is determined to have output the correct answer into a class predicted by the deep learning model 150.

For example, when the analyzer 120 determines that the deep learning model 150 has output the correct answer in FIG. 3, the analyzer 120 may determine the first image data as test image data by determining that the class of the first image data corresponding to the result is [dog]. On the other hand, when the analyzer 120 determines that the deep learning model 150 has output an incorrect answer, the analyzer 120 cannot determine the class of the first image data corresponding to the result, and thus the first image data corresponding to the result cannot be determined as a test image.

According to one embodiment, the analyzer 120 may transmit the first image data determined as test image data to the image processor 110.

According to another embodiment, the analyzer 120 may transmit information of the first image data determined as test image data to the image processor 110, and the image processor 110 may receive the information and determine the first image data as test image data.

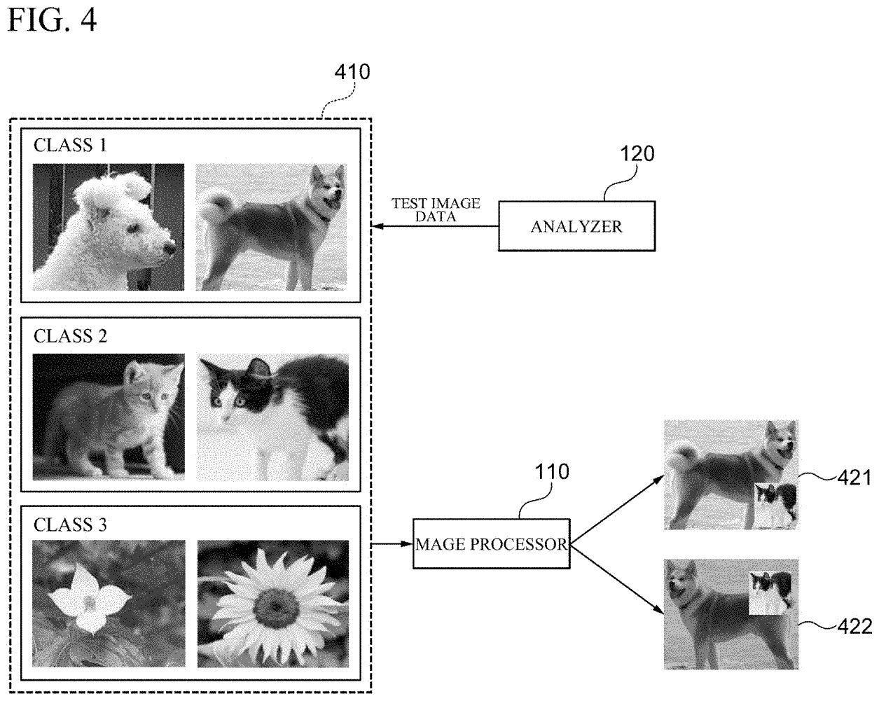

FIG. 4 is an exemplary diagram for explaining an operation of the image processor according to an embodiment.

Referring to FIG. 4, the analyzer 120 may transmit determined test image data 410 to the image processor 110.

According to an embodiment, the image processor 110 may receive the first image data determined by the analyzer 120 as test image data, and generate N third image data by synthesizing two or more first image data that are classified into different classes among the first image data determined as test image data.

For example, the test image data received by the image processor 110 from the analyzer 120 is either the first image data itself that is determined by the analyzer 120 as the test image data, or information of the first image data designated as the test image data, such as an identification number or index of the first image data.

For example, as shown in FIG. 4, the analyzer 120 may determine test image data containing a class regarding [dog], a class regarding [cat], and a class regrading [flower]. Then, the image processor 110 may generate third image data by synthesizing two or more first images belonging to different classes.

Referring to FIG. 4, the image processor 110 may generate two third image data 421 and 422 based on the first image data belonging to [dog] class and the first image belonging to [cat] class.

According to an example, the image processor 110 may synthesize two or more first images belonging to different classes and at the same time may apply any one of the following methods: rotation, flip, resize, distortion, crop, cutout, blur, and mix, or a combination of two or more thereof.

For example, the image processor 110 may generate third image data by rotating first image data belonging to [dog] class and then synthesizing the rotated first image data with the first image belonging to [cat] class.

According to one embodiment, the analyzer 120 may analyze whether the deep learning model has output a correct answer by receiving N output data obtained by predicting each of N third image data into a specific class from the deep learning model. For example, the apparatus for evaluating the performance of a deep learning model may operate in the same manner as in the embodiments described with reference to FIGS. 1 to 3.

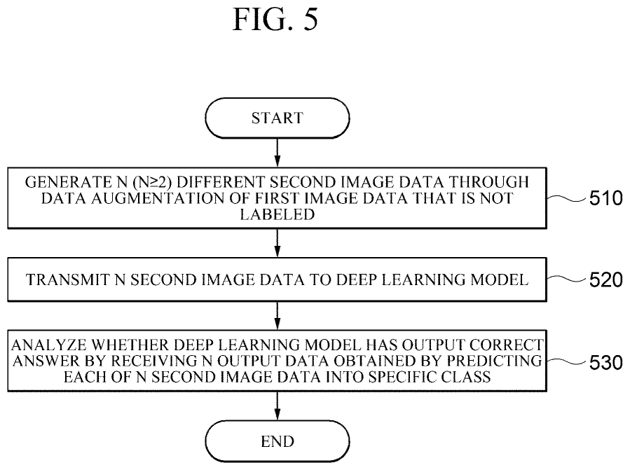

FIG. 5 is a flowchart illustrating a method of evaluating the performance of a deep learning model according to an embodiment.

Referring to FIG. 5, an apparatus for evaluating the performance of a deep learning model may generate N (N≥2) different second image data through data augmentation of first image data that is not labeled (510).

According to one embodiment, the apparatus for evaluating the performance of a deep learning model may generate N (N≥2) different second image data through data augmentation of first image data that is not labeled. Then, the apparatus for evaluating the performance of a deep learning model may transmit the second image data to the deep learning model.

According to an example, data augmentation may be any one of the following methods: rotation, flip, resize, distortion, crop, cutout, blur, and mix, or a combination of two or more thereof.

For example, the apparatus for evaluating the performance of a deep learning model may generate the second image data by applying rotation to one first image data. In another example, the apparatus for evaluating the performance of a deep learning model may generate the second image data by applying rotation and flip to one first image data. In still another example, the apparatus for evaluating the performance of a deep learning model may generate the second image data by synthesizing two or more first images.

According to an embodiment, the apparatus for evaluating the performance of a deep learning model may generate different second image data by applying the same type of data augmentation to the first image data.

For example, the apparatus for evaluating the performance of a deep learning model may receive M first image data, and may generate N second image data for each of the M first image data by applying rotation to the M first image data.

In another example, the apparatus for evaluating the performance of a deep learning model may receive M first image data, and generate N second image data for each of the M first image data by applying rotation and flip to the M first image data.

According to an embodiment, the apparatus for evaluating the performance of a deep learning model may generate different second image data by applying different types of data augmentation to the first image data.

For example, the apparatus for evaluating the performance of a deep learning model may receive M first image data, rotate some of the M first image data to generate N second image data for each of some of the M first image data, and flip the remaining first image data to generate N second image data for each of the remaining first image data.

In another example, the apparatus for evaluating the performance of a deep learning model may receive M first image data, apply rotation and flip to some of the M first image data to generate N second image data for each of some of the M first image data, and apply distortion and cutout to the remaining first image data to generate N second image data for each of the remaining first image data.

According to an embodiment, the apparatus for evaluating the performance of a deep learning model may transmit N second image data to the deep learning model (520).

According to an example, the apparatus for evaluating the performance of a deep learning model may transmit predetermined image data for evaluating the performance of the deep learning model to the deep learning model, and may receive and analyze output data obtained by analyzing the predetermined image data from the deep learning model.

According to an embodiment, the apparatus for evaluating the performance of a deep learning model may analyze whether the deep learning model has output a correct answer by receiving N output data obtained by predicting each of N second image data into a specific class from the deep learning model (530).

For example, as shown in FIG. 3, the deep learning model may predict a class of each of four second image data as [dog, dog, dog, dog] and generate output data according to the prediction result, or may predict the class as [dog, dog, cat, dog] and generate output data. Then, the deep learning model may transmit the generated output data to the apparatus for evaluating the performance of a deep learning model.

According to an embodiment, the apparatus for evaluating the performance of a deep learning model may compare classes indicated by the N output data, and when all indicated classes are the same, it may be determined that the deep learning model has output a correct answer.

For example, where classes indicated by output data received by the apparatus for evaluating the performance of a deep learning model are [dog, dog, dog, dog], the apparatus may compare the classes indicated by the output data and find that all the indicated classes are the same. Then, the apparatus for evaluating the performance of a deep learning model may determine that the deep learning model has output a correct answer since the finding corresponds to a case where all classes indicated by the output data are the same.

In another example, where classes indicated by the output data received by the apparatus are [dog, dog, cat, dog], the apparatus may compare the classes indicated by the output data and find that the indicated classes are not the same. Then, the apparatus for evaluating the performance of a deep learning model may determine that the deep learning model has output an incorrect answer since the finding does not correspond to a case where all classes indicated by the output data are the same.

According to an embodiment, the apparatus for evaluating the performance of a deep learning model may check the number of each class indicated by the N output data, and, when the ratio of the largest number of classes to the total number of classes is greater than or equal to a predetermined reference, the apparatus may determine that the deep learning model has output a correct answer.

For example, as shown in FIG. 3, the deep learning model may receive four second image data and generate output data according to four prediction results. For example, when classes indicated by three or more output results among the four prediction results are the same, the apparatus for evaluating the performance of a deep learning model may determine that the deep learning model has output a correct answer.

For example, where classes indicated by the output data received by the apparatus are [dog, dog, dog, dog], the apparatus may check the number of each class indicated by the output data, and as a result of checking, may find that the number of [dog] classes is 4. Then, the apparatus for evaluating the performance of a deep learning model may determine that the deep learning model has output a correct answer since the number of [dog] classes is three or more among the classes indicated by the output data.

In another example, where classes indicated by the output data received by the apparatus are [dog, dog, cat, dog], the apparatus may check the number of each class indicated by the output data and as a result of checking, may find that the number of [dog] classes is 3 and the number of [cat] classes is 1. Then, the apparatus for evaluating the performance of a deep learning model may determine that the deep learning model has output a correct answer since the number of [dog] classes is three or more among the classes indicated by the output data.

According to an embodiment, the apparatus for evaluating the performance of a deep learning model may generate N third image data by synthesizing two or more first image data classified into different classes among the first image data determined as test image data.

For example, when the apparatus determines that the deep learning model has output the correct answer in FIG. 3, the apparatus may determine the first image data as test image data by determining that the class of the first image data corresponding to the result is [dog]. On the other hand, when the apparatus determines that the deep learning model has output an incorrect answer, the apparatus cannot determine the class of the first image data corresponding to the result, and thus the first image data corresponding to the result cannot be determined as a test image.

According to an embodiment, the apparatus for evaluating the performance of a deep learning model may generate N third image data by synthesizing two or more first image data classified into different classes among the first image data determined as test image data.

For example, as shown in FIG. 4, the apparatus for evaluating the performance of a deep learning model may determine test image data containing a class regarding [dog], a class regarding [cat], and a class regarding [flower]. Then, the apparatus for evaluating the performance of a deep learning model may generate third image data by synthesizing two or more first images belonging to different classes.

Referring to FIG. 4, the apparatus for evaluating the performance of the deep learning model may generate two third image data 421 and 422 based on the first image data belonging to [dog] class and the first image belonging to [cat] class.

According to an example, the apparatus may synthesize two or more first images belonging to different classes and at the same time may apply any one of the following methods: rotation, flip, resize, distortion, crop, cutout, blur, and mix, or a combination of two or more thereof.

For example, the apparatus for evaluating the performance of a deep learning model may generate third image data by rotating first image data belonging to [dog] class and then synthesizing the rotated first image data with the first image belonging to [cat] class.

According to an embodiment, the apparatus for evaluating the performance of a deep learning model may analyze whether the deep learning model has output a correct answer by receiving N output data obtained by predicting each of N third image data into a specific class from the deep learning model. For example, the apparatus for evaluating the performance of a deep learning model may operate in the same manner as in the embodiments described with reference to FIGS. 1 to 3.

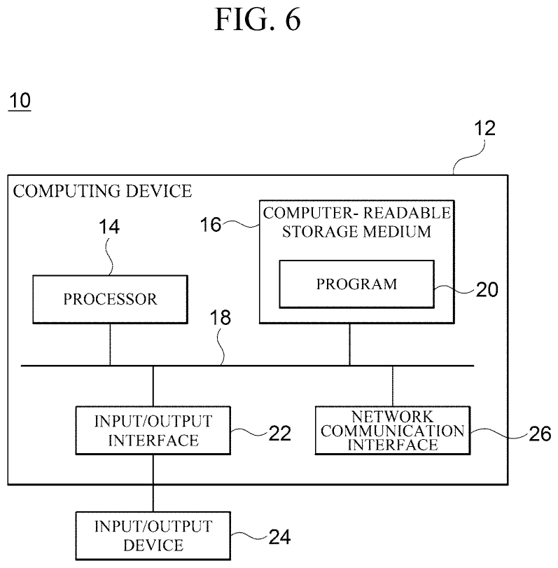

FIG. 6 is a block diagram illustrating an example of a computing environment including a computing device according to an embodiment.

In the illustrated embodiment, each of the components may have functions and capabilities different from those described hereinafter and additional components may be included in addition to the components described herein.

The illustrated computing environment 10 includes a computing device 12. In one embodiment, the computing device 12 may be one or more components included in the apparatus 100 for evaluating the performance of a deep learning model. The computing device 12 includes at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable instructions, and the computer executable instructions may be configured to, when executed by the processor 14, cause the computing device 12 to perform operations according to the exemplary embodiment.

The computer-readable storage medium 16 is configured to store computer executable instructions and program codes, program data and/or information in other suitable forms. The programs stored in the computer-readable storage medium 16 may include a set of instructions executable by the processor 14. In one embodiment, the computer-readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

While the present disclosure has been described in detail above with reference to representative exemplary embodiments, it should be understood by those skilled in the art that the exemplary embodiments may be variously modified without departing from the scope of the present disclosure. Therefore, the scope of the present disclosure is defined not by the described exemplary embodiments but by the appended claims and encompasses equivalents that fall within the scope of the appended claims.

1. An apparatus for evaluating performance of a deep learning model, the apparatus comprising:
an image processor configured to generate N different second image data, where N≥2 through data augmentation of first image data that is not labeled and transmit the generated second image data to a deep learning model; and
an analyzer configured to analyze whether the deep learning model has output a correct answer by receiving N output data obtained by predicting each of the N second image data into a specific class from the deep learning model.

2. The apparatus of claim 1, wherein the image processor is further configured to generate the different second image data by applying the same type of data augmentation to the first image data, or generate the different second image data by applying different types of data augmentation to the first image data.

3. The apparatus of claim 1, wherein the analyzer is further configured to compare classes indicated by the N output data and, when all the indicated classes are the same, determine that the deep learning model has output a correct answer.

4. The apparatus of claim 1, wherein the analyzer is further configured to check a number of each class indicated by the N output data and, when a ratio of a largest number of classes is greater than or equal to a predetermined reference, determine that the deep learning model has output a correct answer.

5. The apparatus of claim 1, wherein the analyzer is further configured to determine test image data by classifying first image data for which the deep learning model is determined to have output a correct answer into a class predicted by the deep learning model.

6. The apparatus of claim 5, wherein the image processor is further configured to receive the first image data determined by the analyzer as the test image data and generate N third image data by synthesizing two or more first image data classified into different classes among the first image data determined as the test image data.

7. The apparatus of claim 6, wherein the analyzer is further configured to receive N output data obtained by predicting each of the N third image data into a specific class from the deep learning model and analyze whether the deep learning model has output a correct answer.

8. A method for evaluating performance of a deep learning model, the method comprising:
generating N different second image data, where N≥2, through data augmentation of first image data that is not labeled;
transmitting the N second image data to a deep learning model; and
analyzing whether the deep learning model has output a correct answer by receiving N output data obtained by predicting each of the N second image data into a specific class from the deep learning model.

9. The method of claim 8, wherein the generating of the N different second image data comprises generating the different second image data by applying the same type of data augmentation to the first image data, or generating the different second image data by applying different types of data augmentation to the first image data.

10. The method of claim 8, wherein the analyzing comprises comparing classes indicated by the N output data and, when all the indicated classes are the same, determining that the deep learning model has output a correct answer.

11. The method of claim 8, wherein the analyzing comprises checking a number of each class indicated by the N output data and, when a ratio of a largest number of classes is greater than or equal to a predetermined reference, determining that the deep learning model has output a correct answer.

12. The method of claim 8, wherein the analyzing comprises determining test image data by classifying first image data for which the deep learning model is determined to have output a correct answer into a class predicted by the deep learning model.

13. The method of claim 12, further comprising generating N third image data by synthesizing two or more first image data classified into different classes among the first image data determined as the test image data.

14. The method of claim 13, further comprising receiving N output data obtained by predicting each of the N third image data into a specific class from the deep learning model and analyzing whether the deep learning model has output a correct answer.
